(19) United States
(12) Patent Application Publication
(10) Pub. No.: US 2019/0337046 A1
(43) Pub. Date: Nov. 7, 2019

(54) METHOD AND DEVICE FOR MANUFACTURING ARC-SHAPED COIL SPRING

(71) Applicant: TECH CORPORATION, Tochigi (JP)

(72) Inventor: Takeshi SUGITA, Tochigi (JP)

(21) Appl. No.: 16/077,871

(22) PCT Filed: May 18, 2017
(86) PCT No.: PCT/JP2017/018639

§ 371 Date: Aug. 14, 2018

(30) Foreign Application Priority Data
May 25, 2016 (JP) 2016-104363

(51) Int. Cl. B21F 35/02; B21F 3/06

(52) U.S. Cl. CPC B21F 35/02; F16D 13/64; B21F 3/06

(57) ABSTRACT

The present invention is provided focusing on a servo press configured to enable high-speed/high-accuracy operation by numeric value control in the method for manufacturing an arc-shaped coil spring. The present invention provides a manufacturing method and a manufacturing device configured so that the curvature of the arc-shaped coil spring can be freely ensured. The manufacturing method includes the clamp step of fixing a straight cylindrical coil spring, the end portion detection step of detecting an end portion, a rotation angle position determination step, a pitch feeding step, a pressing member insertion step, and an insertion direction conversion step. The manufacturing method and the manufacturing device relate to the technology of continuously repeating the operation of pushing down a pressing member to an inter-pitch from above, thereby deforming the straight cylindrical coil spring into the coil spring with the curvature.

### TECHNICAL FIELD

The present invention relates to an arc-shaped coil spring manufacturing method. Specifically, the present invention relates to the following technology. According to this technology, an optional shape of a coil spring curved in an arch shape, such as a curvature and a non-equal length, can be processed with high accuracy in such a manner that a pressing member is pushed against a cylindrical coil spring shaped on a straight line to plastically deform the coil spring.

### BACKGROUND ART

An arc-shaped coil spring is used for, e.g., a clutch of an automatic transmission of an automobile. The arc-shaped coil spring plays an important role in a rotation power transmission system having a clutch structure, the rotation power transmission system including an automobile. For example, the arc-shaped coil spring is configured to absorb impact and vibration generated upon connection/disconnection of a clutch and fine fluctuation of rotation output of an engine.

In an automobile field, performance required for a clutch portion has been increased more than ever. In a case where the clutch portion is used in combination with a motor in a hybrid car, compactness with high performance, and enhancement of large torque receptivity have been demanded for the clutch portion, for example. For this reason, the arc-shaped coil spring responding to even these demands has been demanded.

Regarding these demands for the arc-shaped coil spring, specific demands for product specifications based on problem resolution at a manufacturing stage have been currently increased. The specific demands include; for example, polished surfaces of both end portions of the arc-shaped coil spring, the polished surfaces being perpendicular to a rotation axis; a shortest portion of a wire rod of the spring spring, the shortest portion being positioned at a determined angle at the polished surface; the arc-shaped coil spring without torsion; the spring with a non-equal interval; and extension/contraction operation suitable upon extension/contraction of the on-the-arc coil spring.

Basically, straight coil spring manufacturing is a widely-known general technology in terms of industries. In straight coil spring manufacturing, manufacturing of a product tailored to manufacturer specifications with a favorable yield ratio has been required. Meanwhile, an arc-shaped coil spring manufacturing method includes, in many cases, manufacturing of the arc-shaped coil spring from the straight coil spring. For the arc-shaped coil spring manufacturing method, various mass production technologies have been developed.

Specifically, Patent Literatures 1 and 2 describe, as an arc-shaped coil spring, a damper coil spring incorporated in a clutch housing, for example. However, the manufacturing method has not been set. Patent Literatures 1 and 2 refer to a design with a non-equal pitch, but fail to describe a manufacturing method based on such a design.

Moreover, a patent mentioned in Literature 3 described in Patent Literature 3 discloses the following technology. This technology relates to the method for easily forming an arc-shaped coil spring from a straight coil spring. In this technology, the spring is subjected to thermal treatment while being held in a curved state by insertion of an arc-shaped cored bar into a coil inner diameter side. Patent Literature 3 also discloses a gradual decrease in a curvature radius toward each end side as compared to a coil spring center portion upon the thermal treatment of the curved spring, an annealing step performed in advance of arc molding, a heating step before arc formation, and a cutting step before arc molding, as well as disclosing enhancement by shot peening and a technology such as low-temperature annealing. However, in this method, the cored bar and the spring are not fixed. For this reason, they are freely rotatable. Patent Literature 3 fails to describe or suggest fixing of an end portion. Patent Literature 3 describes curvature distribution across the entirety of the spring. However, Patent Literature 3 fails to describe or suggest the method for fixing the curvature distribution at the freely-rotatable spring and manufacturing the spring. According to the present application, only one end portion is fixed while a curvature is formed as needed. On this point, the present application is greatly different from Patent Literature 3. That is, in the present application, the state in which one end portion is fixed and each end is held on one side is used, and the curvature is formed at a free state. Thus, the curvature can be freely formed by numeric value control at a designed position. On this point, the present application is greatly different from Patent Literature 3.

A patent described in Patent Literature 4 describes an arc-shaped coil spring manufacturing device. According to a configuration described in Patent Literature 4, a pair of movable cylindrical pressing metal tools and a pair of movable walls are used. The pair of movable cylindrical pressing metal tools is configured to horizontally arrange straight coil springs in parallel along an axis by information of an inner peripheral surface and to curve the coil springs. The pair of movable walls is configured to be body-available inserted into a fixed receiving metal tool and to contact both end surfaces of each coil spring. A method using the cored bar of Patent Literature 3 is illustrated as the prior art in FIG. 8. Multiple manufactures can be possible at the same time, but free curvature distribution with respect to the positions of the number of turns is not achieved. Thus, it is difficult to optionally provide a structure providing a resonance prevention effect by allowing the spring to have spring property change distribution therein, a clutch spring requiring the resonance prevention effect.

A patent described in Patent Literature 5 describes the arc-shaped coil spring manufacturing device of Patent Literature 4. A characteristic of the patent described in Patent Literature 5 is that a locking plate for fixing, during heating, a structure to be pushed against a coil spring is provided. The locking plate is indicated by “8” and “9” in the figures. Patent Literature 5 is similar to Patent Literature 4 in a point that multiple manufactures can be manufactured at the same time. However, free curvature distribution with respect to the positions of the number of turns is not achieved. Thus, it is difficult to optionally provide a structure providing a resonance prevention effect by allowing the spring to have spring property change distribution therein, a clutch spring requiring the resonance prevention effect.

According to a figure of a patent described in Patent Literature 6, a damper spring coil shape is an oval shape. The effect of stable action of spring force caused by absorbing a position shift upon spring setting is described. However, the patent described in Patent Literature 6 is greatly different in a point that the patent described in Patent Literature 6 is not a patent relating to a manufacturing method as in the present application, but an application of a coil spring itself. The patent described in Patent Literature 6 specifically focuses on a contact portion. That is, it can be said that the patent described in Patent Literature 6 focuses, on a point that the effect of contact of a straight portion at an end portion of the coil spring, on the effect that the end surface of the arc-shaped coil spring is in surface contact as one of ideas of the present application. However, the manufacturing method itself is different in a point that contact is made across the entire circumference of the coil surface.

A patent described in Patent Literature 7 describes an arc-shaped coil spring manufacturing method. The patent described in Patent Literature 7 describes a housing jig and a pressing jig. However, the patent described in Patent Literature 7 fails to describe detailed arc-shape distribution with respect to coil spring turn positions, but describes the step of heating while fixing in a groove. The patent described in Patent Literature 7 is different from the present application in a point of heating while fixing in an arc shape.

A patent described in Patent Literature 8 describes a technology including the step of first pushing and expanding a straight cylindrical coil spring, the step of clamping the straight cylindrical coil, and the pitch dimension adjustment step of pushing and expanding part of the coil by a pitch adjustment tool to deform the composition of the coil to plastically deform the coil. The patent described in Patent Literature 8 describes a coil spring manufacturing method characterized in that composition deformation is continuously performed by pushing and expanding adjacent ones of coil turns by action on between adjacent ones of the coil turns of the straight cylindrical coil from the same side, thereby shaping the straight cylindrical coil into a curved coil spring. This patent filed in 1997 employs a cam press method. FIG. 1 illustrates an example where feeding operation is performed in the axial direction of the straight cylindrical coil spring to perform the operation of pushing and expanding the straight cylindrical coil spring by using the same press device. The patent described in Patent Literature 8 does not arrive at end surface direction control performed such that both coil end surfaces contacting a case of a clutch housing are parallel to each other while closely contacting the case of the clutch housing in the arc-shaped coil spring manufacturing method solved by the present application. The patent described in Patent Literature 8 fails to describe or suggest intentional formation of the arc-shaped curvature distribution in the circumferential direction as in the application of Patent Literature 1.

### CITATION LIST

### Patent Literature

PATENT LITERATURE 1: JP-A-10-82440
PATENT LITERATURE 2: JP-A-01-320330
PATENT LITERATURE 3: JP-A-2007-268573
PATENT LITERATURE 4: JP-A-2014-231069
PATENT LITERATURE 5: JP-A-2014-223656
PATENT LITERATURE 6: JP-A-8-4835
PATENT LITERATURE 7: JP-A-2000-129359
PATENT LITERATURE 8: JP-A-11-019734

### SUMMARY OF THE INVENTION

### Problems to be Solved by the Invention

For these reasons, the inventor(s) of the present application has, for solving the problems according to the present invention, focused on a servo press enabling high-speed/high-accuracy operation by numeric value control. In the present invention, the arc-shaped coil spring manufacturing method is provided.

### Solutions to the Problems

The present invention relates to the method for manufacturing a coil spring with a curvature from a straight cylindrical coil spring. The present method employs the following technology as a technique. The present method includes the first clamp step of fixing the straight cylindrical coil spring; the end portion detection step of detecting an end portion; a rotation angle position determination step; a first pitch feeding step; a first pressing member insertion step; the insertion direction conversion step of converting an insertion direction with respect to the coil spring; a second pitch feeding step; and a second pressing member insertion step. In the present method, the insertion direction conversion step is the step of fixing, at the second clamp step, an opposite end portion of the back end portion at the first pressing member insertion step and deactivating the first clamp step to reverse a feeding direction of a pressing member. The first pressing member insertion step and the second pressing member insertion step are the steps of continuously repeating the operation of pushing down the pressing member to an inter-pitch from above, thereby deforming the straight cylindrical coil spring into the arc-shaped coil spring with the curvature. For a deformation amount, the operation of the pressing member to the vicinity of the coil spring, the operation of the pressing member from a position after the operation until the pressing member contacts the coil spring, the operation of holding push-down or repeating push-down at least one or more times after contact after operation, and the operation of pulling out the pressing member are each controlled to proper speeds such that shaping into a shape with an optional curvature is performed.

Moreover, the present invention may employ, as a technique, controlling the operation of the pressing member by using a servo press.

Further, the present invention may employ, as a technique, determining a position by using a metal sensor or an image sensor as a detection unit for a rotation angle at the rotation angle position determination step and/or for the end portion at the end portion detection step.

In addition, the present invention may employ, as a technique, utilizing, at the first pressing member insertion step and the second pressing member insertion step, the shape of a die against which the coil spring is pushed when the pressing member pushes and expands the coil spring, the shape of the die not interfering with the arc-shaped coil spring after shaping.

Moreover, the present invention may employ, as a technique, utilizing, at the first pressing member insertion step and the second pressing member insertion step, a guide plate configured to suppress, with a certain clearance, deformation and movement of the coil spring by the pressing member.

Further, the present invention may employ, as a technique, having, at the first pressing member insertion step and the second pressing member insertion step, an elastic body structure for absorbing position deviation due to repulsion generated in the axial direction of the coil spring upon insertion f the pressing member.

In addition, the present invention may employ, as a technique, having, by the pressing member, such a shape that one side on which two surfaces of a rectangle of a triangular prism are connected together faces downward and including the pressing member while providing an inclination angle within a range of equal to or less than ½ of an average inclination angle of a wire diameter of a single turn from a direction perpendicular to the continuous axial direction.

Moreover, the present invention is a manufacturing device for manufacturing an arc-shaped coil spring from a straight cylindrical coil spring. The present device may employ the following technology as a technique. The present device includes a first clamp mechanism configured to fix the straight cylindrical coil spring; an end portion detection sensor configured to detect an end portion; a rotation angle position determination mechanism; a pitch feeding mechanism; a pressing member insertion mechanism; and an insertion direction conversion mechanism configured to convert an insertion direction with respect to a coil spring. The pressing member insertion mechanism operates a pressing member by control using a servo press. The pressing member has such a shape that one side on which two surfaces of a rectangle of a triangular prism are connected together faces downward. The present device includes a mechanism configured to adjust the one side within a range of equal to or less than ½ of an average inclination angle of a wire diameter of a single turn from a direction perpendicular to the axial direction of the coil spring. The present device continuously repeats, by operation of the pressing member, the operation of pushing down the pressing member to an inter-pitch portion from above such that the straight cylindrical coil spring is deformed into the arc-shaped coil spring.

Further, the present invention may use, as a technique, including a control device configured to control push-down amount and push-down speed of the pressing member in a stepwise manner for each pitch of the coil spring in operation by the pressing member insertion mechanism.

In addition, in the present invention, a rotation angle detection mechanism 121 in the rotation angle position determination mechanism may be a metal sensor or an image sensor.

Moreover, the present invention may employ a configuration in which when the pressing member pushes and expands the coil spring in the pressing member insertion mechanism, the shape of a die against which the coil spring is pushed is a shape not interfering with the arc-shaped coil spring after shaping.

Further, the present invention may employ a configuration having a guide plate configured to suppress, with a certain clearance, deformation and movement of the coil spring subjected to insertion by the pressing member insertion mechanism.

In addition, the present invention may employ a configuration having an elastic structure configured to absorb repulsion generated at the coil spring when the pressing member is inserted by the pressing member insertion mechanism.

### Advantageous Effects of the Invention

The arc-shaped coil spring manufacturing method according to the present invention provides the following excellent advantageous effects. That is, in the process of manufacturing the arc-shaped coil spring manufactured from the straight cylindrical coil spring, the arc-shaped coil spring can be manufactured without occurrence of lowering of processing accuracy regarding a rotation direction and the spring shape after a product process such as quenching and/or annealing.

Moreover, the arc-shaped coil spring manufacturing method according to the present invention provides an excellent advantageous effect enabling manufacturing of a coil spring in a desired shape. This is because speed control using the servo press at the pressing member insertion step enables high-speed and high-accuracy plastic deformation for each pitch of a winding of the coil spring.

Further, the arc-shaped coil spring manufacturing method according to the present invention provides the following excellent advantageous effects. That is, not only an arc-shaped coil spring with a certain curvature, but also an arc-shaped coil spring having a shape with curvatures varying in a stepwise manner or partially can be processed.

In addition, the arc-shaped coil spring manufacturing method according to the present invention provides the following excellent advantageous effects. That is, in a clamp structure, in a case where a clamp device having a rectangular or circular shape in accordance with the outer shape of the coil spring is used on one side and a clamp device having the configuration for sandwiching the coil spring from both sides by a flat surface structure is used on the other side, conversion of the insertion direction of the pressing member does not influence accuracy, and strain and torsion due to switching of the clamp can be prevented.

### BRIEF DESCRIPTION OF THE DRAWINGS

FIG. 1 is a flowchart of a procedure of an arc-shaped coil spring manufacturing method according to the present invention.

FIG. 2 illustrates views for describing rotation position determination for a contact surface of an end portion of an arc-shaped coil spring according to the present invention.

FIG. 3 is a view for describing an entire configuration of a straight cylindrical coil spring according to the present invention.

FIG. 4 illustrates views for describing the inter-pitch angle of the arc-shaped coil spring according to the present invention.

FIG. 5 illustrates views for describing a processing state according to the present invention.

FIG. 6 illustrates views for describing operation at a pressing member insertion step according to the present invention.

FIG. 7 illustrates views for describing adjustment of attachment state of a pressing member according to the present invention.

FIG. 8 is a view for describing an entire configuration of an arc-shaped coil spring manufacturing device according to the present invention.

### DESCRIPTION OF EMBODIMENTS

Hereinafter, an embodiment of the present invention will be described with reference to the drawings. Note that a manufacturing method and a manufacturing device according to the present invention are part of a material shaping step before thermal treatment in the entire step of forming an arc-shaped coil spring. A “straight cylindrical coil spring” means a core before a curvature is provided. The “arc-shaped coil spring” means an arc-shaped coil spring material shaped in such a manner that the curvature is provided to the straight cylindrical coil spring before the thermal treatment.

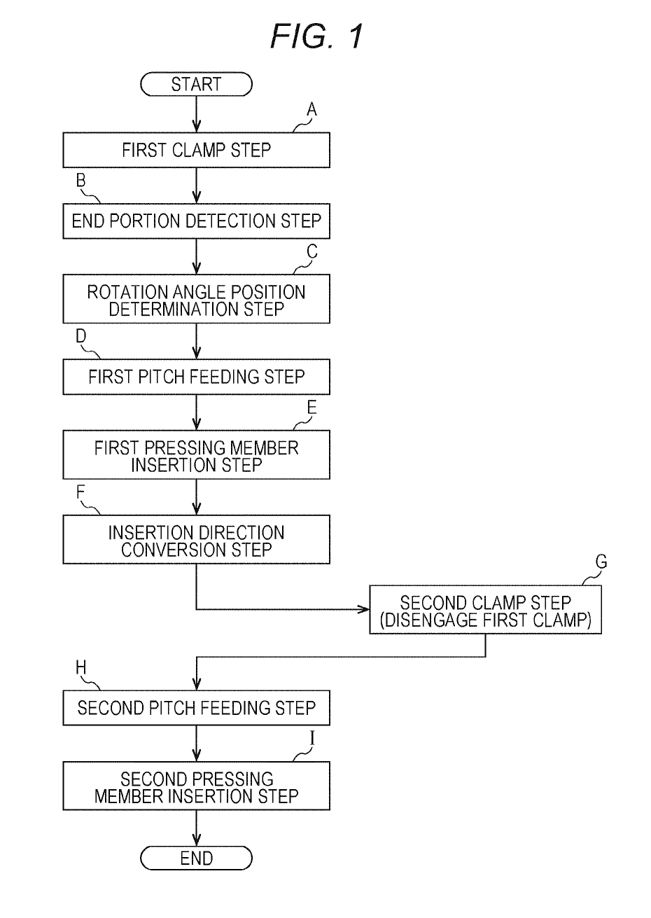

FIG. 1 is a flowchart of a basic procedure of an arc-shaped coil spring manufacturing method 1 according to the present invention. FIG. 1 shows an entire process flow. Specifically, the arc-shaped coil spring manufacturing method 1 includes a first clamp step A, an end portion detection step B, a rotation angle position determination step C, a first pitch feeding step D, a first pressing member insertion step E, an insertion direction conversion step F, a second clamp step G, a second pitch feeding step H, and a second pressing member insertion step I. The arc-shaped coil spring manufacturing method 1 has the following characteristics. At the first clamp step, the straight coil spring is fixed. At the rotation angle position determination step, an end of a wire rod of the straight cylindrical coil spring is detected, and is arranged at a preset rotation position. At the pitch feeding step, the straight cylindrical coil spring is, after the each rotation position determination step, moved to a predetermined position for the pressing member insertion step. At the pressing member insertion step, a pressing member in the form of a pressing member is pushed in an inter-pitch portion of the coil spring, and accordingly, the coil spring plastically deforms. At the insertion direction conversion step, the pitch feeding step and the pressing member insertion step are repeated a predetermined number of times, and then, are further repeated with a clamp position having been switched for processing from the opposite side. In this manner, the entirety of the coil spring is shaped.

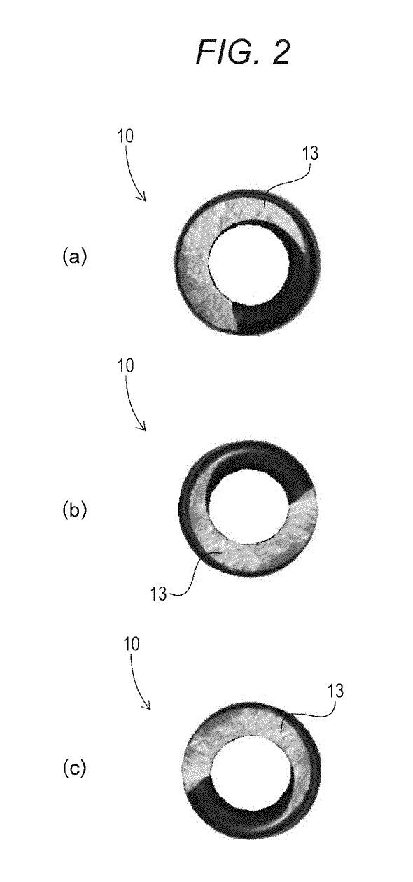

FIG. 2 illustrates a finishing state of an end surface of an arc-shaped coil spring 30 according to the present invention. Further, FIG. 2 illustrates views for describing rotation of the coil spring with the arrangement position of an equal contact surface 13 with respect to an axial direction being specified. First, processing before thermal treatment of the straight cylindrical coil spring preferably includes cutting of the end surface and further finishing of the end surface into a planer shape by polishing and the like. Further, finishing is preferably performed such that the two-thirds or more of the entirety of the flat surface is to be in surface contact with a surface contacting the coil spring.

When the end surface of the coil spring is polished, the contact surface which is to be in contact with a holder and the like is, as illustrated in each view of FIGS. 2(a) to 2(c), provided at a shiny portion in a substantially crescent moon shape (this surface will be hereinafter referred to as an “equal contact surface”). In the arc-shaped coil spring 30, a surface for transmitting spring force of the spring is each end of the coil. FIGS. 2(a) to 2(c) are illustrated while a rotation direction is shifted. In some cases, rotation angles at which one polished surface and a wire rod terminal end portion are arranged need to be specified. Thus, FIGS. 2(a) to 2(c) are illustrated so that a difference in a processing start angle can be compared by rotating the one polished surface and the wire rod terminal end portion to the specified positions.

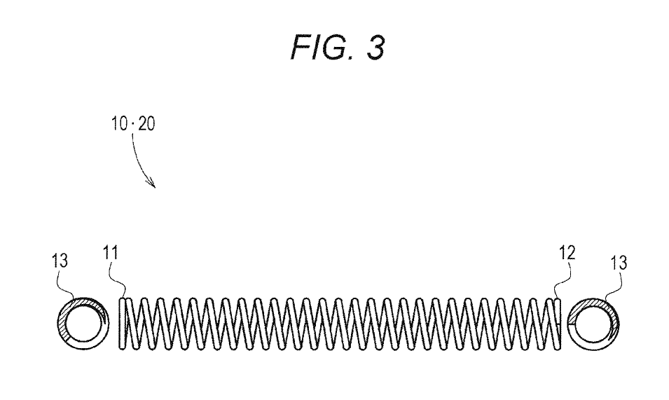

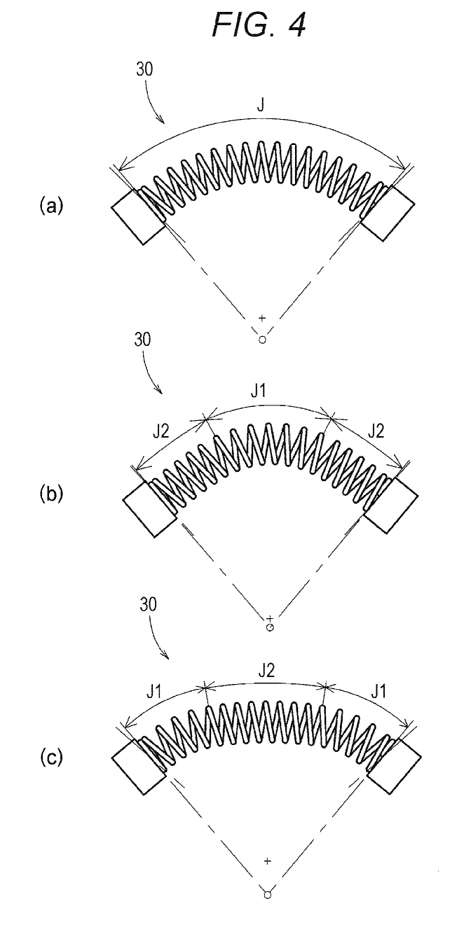

FIG. 3 is a basic configuration explanatory view for describing a basic configuration of a straight cylindrical coil spring 20. The straight cylindrical coil spring 20 is a material before shaping of the arc-shaped coil spring 30. As in a typical case, various conditions are, in the arc-shaped coil spring 30, required for both end sections of the arc-shaped coil spring 30 according to the present invention. The condition of performing plastic deformation at a position specified with an attachment angle may be required for an arc created by the arc-shaped coil spring 30, the attachment angle obtained by considering arrangement of the equal contact surfaces 13. A stable operation requirement needs to be satisfied by angle setting according to each specification, such as a lower side of FIG. 2(a), 90 degrees on a lateral side of FIG. 2(b), and an upper side of FIG. 2(c) (see FIG. 4). Note that the coil spring under processing includes both of a straight cylindrical portion and an arc-shaped portion. Thus, the arc-shaped coil spring 30 and the straight cylindrical coil spring 20 are hereinafter referred to as a “coil spring 10.” Note that the straight cylindrical coil spring 20 is the material before shaping of the arc-shaped coil spring 30.

FIG. 3 illustrates the straight cylindrical coil spring 20. The straight cylindrical coil spring 20 is the material of the arc-shaped coil spring 30 to be manufactured by the arc-shaped coil spring manufacturing method 1 according to the present invention. FIG. 3(a) illustrates a side view. FIG. 3(b) illustrates one end surface.

FIG. 4 illustrates a relationship between the contact surface 13 and a receiving surface contacting the contact surface 13 in the arc-shaped coil spring manufacturing method 1 according to the present invention. A free change can be made to the curvature provided to the arc-shaped coil spring 30 according to the present invention. FIG. 4 illustrates examples of the curvature change.

FIG. 4(a) illustrates an example where the inclination (hereinafter referred to as an “inter-pitch angle”) of the wire diameter per coil turn with respect to the axis direction is configured with the same inter-pitch angle J across an entire arch shape. FIG. 4(b) illustrates an arrangement example where a region in the vicinity of the center has a wide inter-pitch angle J1 and a region on each side has an inter-pitch angle J2 with a narrow angle. FIG. 4(c) illustrates, targeted for FIG. 4(b), an arrangement example where the region in the vicinity of the center has a narrow inter-pitch angle J2 and the region on each side has an inter-pitch angle J1 with a wide angle. Note that the curvature is changeable such that the inter-pitch angle gradually changes to increase/decrease at each pitch. However, it is difficult to illustrate such an embodiment. Further, the contents of this technology are obvious. Thus, this embodiment is omitted.

Moreover, FIGS. 4(a) to 4(c) illustrate that the contact surface 13 is not always perpendicular to the center axis of the coil. FIGS. 4(a) to 4(c) illustrate an easy response to the needs for such specifications that an intersection between extended lines of planar directions of the contact surfaces 13 at both ends is not coincident with a rotation axis center. In these specifications, in a case where multiple arc-shaped coil springs 30 are, for example, dispersively arranged in a circumferential direction about a rotation axis, repulsion is generated at the coil end surfaces in a perpendicular direction in a coil incorporated state or a compressed state in which the coils are effectively actuated.

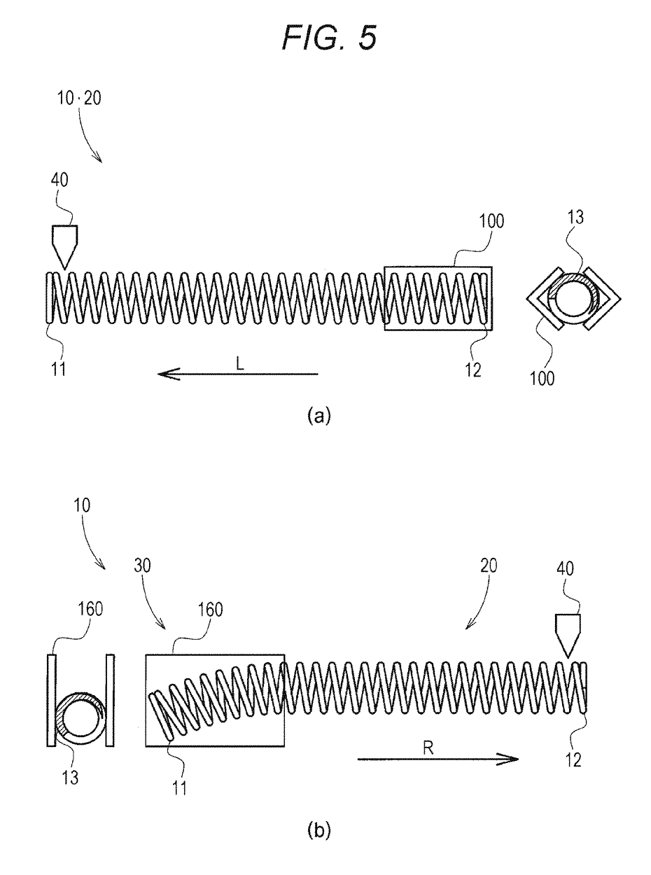

FIG. 5 illustrates views for describing the method for fixing the straight cylindrical coil spring 20 or the arc-shaped coil spring 30 at the first clamp step A or the second clamp step G according to the present invention. FIG. 5(a) illustrates a clamped state in a case where a clamp mechanism is a V-clamp type first clamp mechanism 100. The V-clamp type first clamp mechanism 100 is even applicable to different diameters of the straight cylindrical coil springs 20, and can hold the straight cylindrical coil spring 20. FIG. 5(b) illustrates a clamped state in a case where the clamp mechanism is a flat type second clamp mechanism 160. The flat type second clamp mechanism 160 can hold the arc-shaped coil spring 30 by sandwiching the arc-shaped coil spring 30 from both outer sides. The arc-shaped coil spring 30 is obtained in such a manner that the straight cylindrical coil spring 20 is deformed and curved.

The first clamp mechanism 100 and the second clamp mechanism 160 are not limited to the shape of the V-clamp or the shape of the flat clamp. The first clamp mechanism 100 preferably includes a rotation angle detection mechanism 121 and a rotation angle position determination mechanism 120. The rotation angle detection mechanism 121 is configured to determine the rotation angle position at the rotation angle position determination step C. The rotation angle position determination mechanism 120 can rotate in a circumferential direction about the center axis of the clamp. Note that the rotation angle is based on information obtained by an end portion detection sensor 110 at the material end portion detection step B. That is, a current position is grasped based on end portion position information calculated from the contact area of the contact surface 13. From such a position, the material is further rotated as necessary. This prevents, for example, torsion in the axial direction and curving in an unintended direction. Note that the end portion detection sensor 110 includes, for example, a metal sensor, an optical sensor, and an image sensor.

Specifically, position correction to a proper rotation position needs to be performed for preventing, e.g., torsion caused due to the position of the contact surface 13. For this reason, in the present invention, the mechanism configured to rotate the contact surface to a position with proper arrangement based on the information obtained by the image sensor or the optical sensor in the state of holding by the first clamp. That is, in FIG. 2(b), the upper contact surface is arranged equally on the right and left sides in a balanced manner. Similarly, in FIG. 2(c), the lower contact surface can be arranged equally on the right and left sides in a balanced manner.

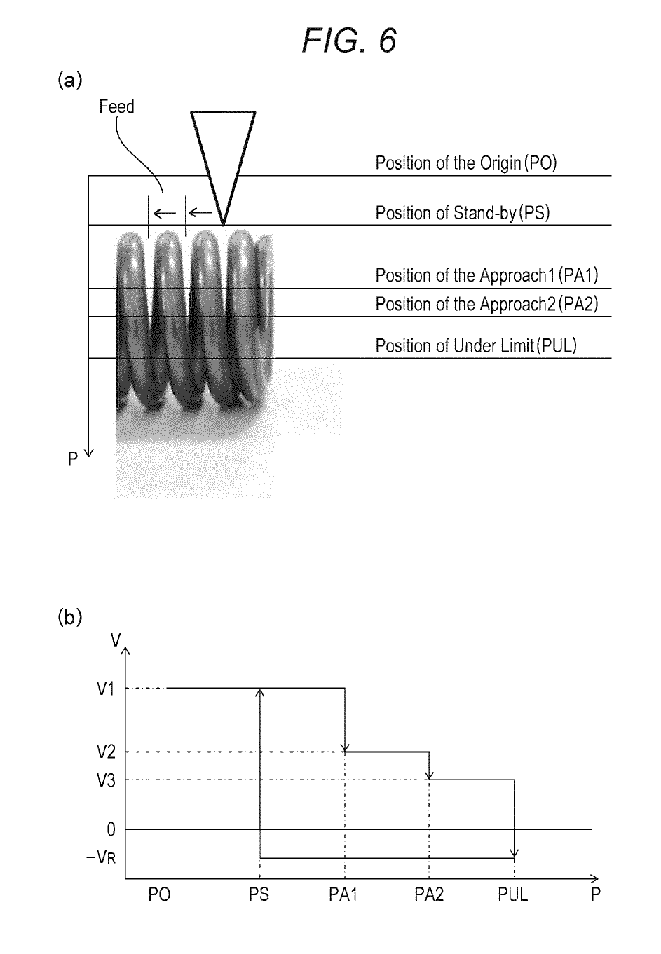

FIG. 6 illustrates views for describing operation of a pressing member 40 at the first pressing member insertion step E and the second pressing member insertion step I according to the present invention. FIG. 6(a) illustrates the insertion depth of the pressing member 40. FIG. 6(b) is the operation explanatory view for describing a change in the insertion depth P of the pressing member 40 and in a speed V upon such insertion. The pressing member 40 is pushed in by a servo press 50. A technical main portion as the greatest characteristic of the present invention is that the operation of inserting the pressing member 40 is controlled in every feeding indicated by “Feed” in FIG. 6(a). Further, the technical main portion as the greatest characteristic of the present invention is also that the following technology is possible. The insertion operation can be performed while the depth and the speed are being changed between the specified positions of the coil. Moreover, not only processing of an equal-length coil spring but also processing of an unequal-length coil spring and the arc-shaped coil spring 30 with different curvatures are possible. Further, various types of high-accuracy processing are possible. The various types of high-accuracy processing include, for example, changing the inter-pitch inclination angle (the inter-pitch angle J) for every region as also illustrated in FIG. 4, and gradually changing the inclination angle for every pitch. Regarding the feeding amount indicated by “Feed” in FIG. 6(a), a feeding direction H at the first pitch feeding step D and the second pitch feeding step will be described with reference to FIG. 5.

In FIG. 5(a), the straight cylindrical coil spring 10 held by the first clamp mechanism 100 is clamped. In FIG. 5(a), the direction of feeding the pressing member 40 at the first pitch feeding step D is a disengagement side from the pressing member 40, i.e., a direction from the clamp mechanism 100 toward a pressing member insertion mechanism 140. In FIG. 5(a), the feeding direction is indicated by an arrow (L). Moreover, FIG. 5(b) illustrates the second pitch feeding step H. In FIG. 5(b), the feeding direction is a direction from the second clamp mechanism 160 to the pressing member 40, and is indicated by an arrow (R).

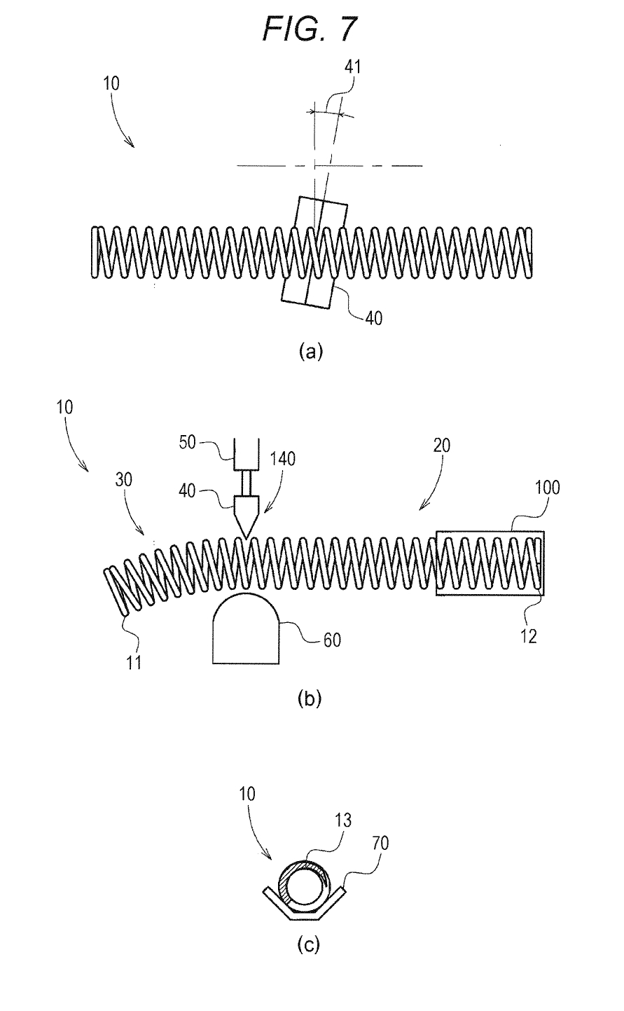

FIG. 7 illustrates adjustment range explanatory views for describing the attachment angle of the pressing member 40. A case where a side on which two surfaces of a rectangle of a triangular prism as he shape of the pressing member 40 are connected together faces downward as illustrated in FIG. 7(a) will be described. In this case, an inclination angle 41 is preferably provided. The inclination angle 41 is within a range from a position to equal to or less than ½ of the average inclination angle of the wire diameter of a single turn, at the position the inclination angle of the side on which the two surfaces of the rectangle are connected together being perpendicular to the axial direction of the coil spring 10. Note that the purpose of the specified inclination angle is that the pressing member 40 is arranged at such an angle that force equally acts on the coil spring deformed and arranged on both sides of the pressing member 40. Such a purpose is not a precisely-specified angle. By properly specifying the angle, torsion of a curved portion of the curved arc-shaped coil spring 30 can be prevented, for example.

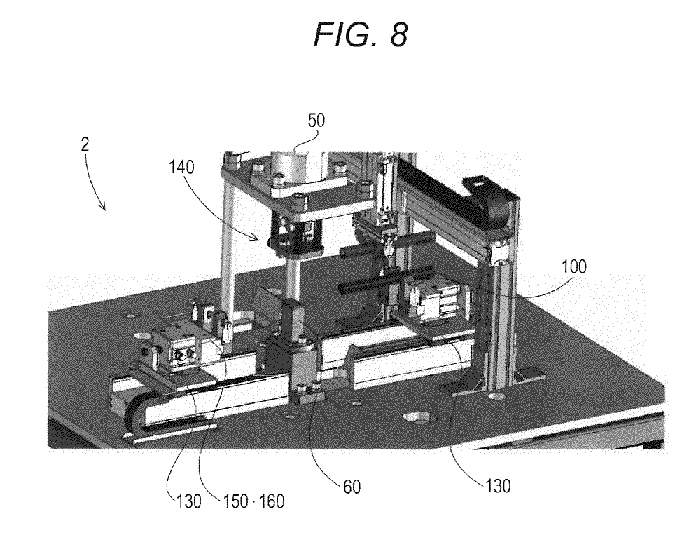

FIG. 8 is a view for describing an entire configuration of an arc-shaped coil spring manufacturing device 2 according to the present invention. The manufacturing device is a device configured to perform the method for manufacturing the arc-shaped coil spring 30. As illustrated in FIG. 8, the arc-shaped coil spring manufacturing device 2 includes the first clamp mechanism 100, the end portion detection sensor 110, the rotation angle position determination mechanism 120, the rotation angle detection mechanism 121, a pitch feeding mechanism 130 by slider control by a servo motor, the pressing member insertion mechanism 140 using the servo press, an insertion direction conversion mechanism 150, and the second clamp mechanism 160. The first clamp mechanism 100 is configured to rotatably fix the straight cylindrical coil spring 20 as the material while sandwiching the straight cylindrical coil spring 20. The metal sensor or the image sensor is used as the end portion detection sensor 110. The rotation angle position determination mechanism 120 is configured in such a manner that a rotation mechanism is provided at the first clamp mechanism 100. For example, the control of the rotation angle of the servo motor and the mechanism of optical detection of a photodiode and the like is used as the rotation angle detection mechanism 121. The insertion direction conversion mechanism 150 is configured to perform the control of switching the insertion mechanism to the opposite direction. In the process of shaping of the arc-shaped coil spring 30, the second clamp mechanism 160 is configured to maintain the state of the portion with the predetermined curvature until the end of insertion processing from holding by the first clamp mechanism 100 while sandwiching such a portion. Each mechanism is a device executed by program control using sequence control and the like. Note that instead of the servo motor, a configuration by an air cylinder utilizing compressed air is also effective. The characteristic mechanisms will be separately described below.

The pitch feeding mechanism 130 is a device configured to move the coil spring 10 to each inter-pitch position of the coil spring 10 to which the pressing member 40 is pushed down. The pitch feeding mechanism 130 moves the coil spring 10 such that one side of a tip end of the pressing member 40 is at a proper position. For the amount of movement of the pitch feeding mechanism 130, input of a specified numeric value and the optical detection mechanism may be used, for example. According a simple technology, operation to be repeated is easily instructed when the amount of movement is constant as in the equal-length coil spring, and therefore, an operation instruction control program is extremely simple. Further, even in a case where the curvature is slightly changed or the complicated arch-shaped coil spring with the partially varying curvature is formed, programming is performed to specifically set a change in the insertion amount and in the speed according to the shape, and therefore, processing into such a shape is possible.

The pressing member insertion mechanism 140 is a device configured to move the pressing member 40 up and down by using the servo press 50. The insertion amount, a push-down position P, and the speed V can be specifically set by the control program. That is, even when a speed change can be controlled in a typical cam drive method as the prior art, it is difficult to freely set the insertion amount and the curvature. On the other hand, by specific setting using the control program according to the present invention, the insertion amount can be slightly changed. Moreover, adjustment of a holding time in a holding state can be also controlled, for example. Thus, in plastic deformation with remaining permanent strain exceeding an elasticity limit, various effects upon designing of the spring are easily calculated. Consequently, the coil spring in the complicated shape, such as a non-equal line shape or a non-equal pitch can be manufactured.

The insertion direction conversion mechanism 150 is a device configured to convert the direction in such a manner that the amount of feeding per step of the pressing member 40 is reversed. In such a structure, the pitch feeding mechanism 130 configured to perform linear movement is controlled by a stepping motor or a servo motor.

The second clamp mechanism 160 is the clamp structure for directly sandwiching, from both sides, the portion deformed in the arch shape at the first pressing member insertion step E. Thus, the clamp shape has a flat plate-shaped sandwiching structure as illustrated in FIG. 5(b). With this structure, the region positioned on the side sandwiched at the first pressing member insertion step E and not subjected to deformation is processed. At this point, the feeding direction at the second pressing member insertion step I is the direction of returning in the direction (the arrow R direction of FIG. 5(b)) opposite to the feeding direction at the first pressing member insertion step E performed previously.

Typically, it has been difficult for a pressing machine and the like to control operation of a pressing portion at the speed V (speeds V of V1, V2, V3, and −VR with respect to the push-down position P as illustrated in FIG. 6) and the number of pressing, for example. The servo press 50 controls the servo motor by using a control unit such as CNC, thereby enabling complicated operation such as operation of the speed V at the pressing portion and the number of pressing. According to the servo press 50, the push-down speed V, the push-down position P (P0, PS, PA1, PA2, PUL), pressing force, and the like, upon processing by the pressing member 40 can be set by numeric values. Moreover, the servo press 50 can perform processing such as high-speed movement until the middle of pressing, deceleration of the speed V at a point near the lowermost point in pressing, and holding at the push-down position P.

A die 60 is a die 60 arranged below the coil spring 10 when the pressing member 40 pushes and expands the coil spring 10. The die 60 has a shape not interfering with a shaped portion of the arc-shaped coil spring 30 during processing. Further, the die 60 is a member configured to receive force accompanied by pushing down of the portion under shaping processing.

Specifically, the curvature of the arc-shaped coil spring 30 is a curvature calculated considering deformation caused in a spring manufacturing step. Deformation caused at the spring manufacturing step includes, for example, the return amount of the elasticity limit during processing of the arc-shaped coil spring, and the amount of deformation at a quenching step. At least the curvature of the die 60 needs to be smaller than the curvature of the arc-shaped coil spring 30.

A guide plate 70 is a guide configured to guide deformation of the coil spring 10 by the pressing member 40 inserted by the pressing member insertion mechanism 140. The guide plate 70 enables shaping of a stable shape to avoid, e.g., strain or torsion in the shape of the arc-shaped coil spring 30 after shaping.

### LIST OF REFERENCE NUMERALS

1 arc-shaped coil spring manufacturing method
2 arc-shaped coil spring manufacturing device
10 coil spring
11 end portion
12 opposite end portion
13 contact surface
20 straight cylindrical coil spring
30 arc-shaped coil spring
40 pressing member
41 inclination angle
50 servo press
60 die
70 guide plate
100 first clamp mechanism
110 end portion detection sensor
120 rotation angle position determination mechanism
121 rotation angle detection mechanism
130 pitch feeding mechanism
140 pressing member insertion mechanism
150 insertion direction conversion mechanism
160 second clamp mechanism
A first clamp step
B end portion detection step
C rotation angle position determination step
D first pitch feeding step
E first pressing member insertion step
F insertion direction conversion step
G second clamp step
H second pitch feeding step
I second pressing member insertion step
J inter-pitch angle
L pitch feeding direction (left)
R pitch feeding direction (right)
P push-down position (P0/PS/PA1/PA2/PUL)
V speed (V1/V2/V3/−VR)

1. An arc-shaped coil spring manufacturing method as a method for manufacturing a coil spring with a curvature from a straight cylindrical coil spring, comprising:
a first clamp step of fixing the straight cylindrical coil spring;
an end portion detection step of detecting an end portion;
a rotation angle position determination step;
a first pitch feeding step;
a first pressing member insertion step;
an insertion direction conversion step of converting an insertion direction with respect to the coil spring;
a second pitch feeding step; and
a second pressing member insertion step,
wherein the insertion direction conversion step is a step of
fixing, at the second clamp step, an opposite end portion of the back end portion at the first pressing member insertion step, and
deactivating the first clamp step to reverse a feeding direction of a pressing member,
the first pressing member insertion step and the second pressing member insertion step are steps of continuously repeating operation of pushing down the pressing member to an inter-pitch from above, thereby deforming the straight cylindrical coil spring into the arc-shaped coil spring with the curvature, and
for a deformation amount,
operation of the pressing member to a vicinity of the coil spring,
operation of the pressing member from a position after the operation until the pressing member contacts the coil spring,
operation of holding push-down or repeating push-down at least one or more times after contact after the operation, and
operation of pulling out the pressing member are each controlled to proper speeds such that shaping into a shape with an optional curvature is performed.

2. The arc-shaped coil spring manufacturing method according to claim 1, wherein
a method of controlling the operation of the pressing member by using a servo press is employed.

3. The arc-shaped coil spring manufacturing method according to claim 1, wherein
a method of determining a position by using a metal sensor or an image sensor as a detector for a rotation angle at the rotation angle position determination step and/or for the end portion at the end portion detection step is employed.

4. The arc-shaped coil spring manufacturing method according to claim 1, wherein
at the first pressing member insertion step and the second pressing member insertion step, a method utilizing a shape of a die against which the coil spring is pushed when the pressing member pushes and expands the coil spring is employed, the shape of the die not interfering with the arc-shaped coil spring after shaping.

5. The arc-shaped coil spring manufacturing method according to claim 1, wherein
at the first pressing member insertion step and the second pressing member insertion step, a method utilizing a guide plate configured to suppress, with a certain clearance, deformation and movement of the coil spring by the pressing member is employed.

6. An arc-shaped coil spring manufacturing device as a manufacturing device for manufacturing an arc-shaped coil spring from a straight cylindrical coil spring, comprising:
a first clamp mechanism configured to fix the straight cylindrical coil spring;
an end portion detection sensor configured to detect an end portion;
a rotation angle position determination mechanism;
a pitch feeding mechanism;
a pressing member insertion mechanism; and
an insertion direction conversion mechanism configured to convert an insertion direction with respect to a coil spring,
wherein the pressing member insertion mechanism operates a pressing member by control using a servo press,
the pressing member has such a shape that one side on which two surfaces of a rectangle of a triangular prism are connected together faces downward as a blade edge,
the one side forming the blade edge is provided with an inclination angle with respect to a center of the coil spring,
a mechanism configured to adjust, as view in plane, the inclination angle within a range of equal to or less than ½ of an opening angle between a direction perpendicular to the center of the coil spring and a line connecting both ends of a wire diameter of a single turn, and
operation of pushing down the pressing member to an inter-pitch from above is continuously repeated by operation of the pressing member such that the straight cylindrical coil spring is deformed into the arc-shaped coil spring.

7. The arc-shaped coil spring manufacturing device according to claim 6, further comprising:
a control device configured to control push-down amount and push-down speed of the pressing member in a stepwise manner for each pitch of the coil spring in operation of the pressing member insertion mechanism.

8. The arc-shaped coil spring manufacturing device according to claim 6, wherein
a rotation angle detection mechanism in the rotation angle position determination mechanism is a metal sensor or an image sensor.

9. The arc-shaped coil spring manufacturing device according to claim 6, wherein
when the pressing member pushes and expands the coil spring in the pressing member insertion mechanism, a shape of a die against which the coil spring is pushed is a shape not interfering with the arc-shaped coil spring after shaping.

10. The arc-shaped coil spring manufacturing device according to claim 6, further comprising:
a guide plate configured to suppress, with a certain clearance, deformation and movement of the coil spring subjected to insertion by the pressing member insertion mechanism.
